(19) United States
(12) Patent Application Publication
(10) Pub. No.: US 2002/0046513 A1
(43) Pub. Date: Apr. 25, 2002

(54) Animal barrier device and method of using thereof

(76) Inventor: Malcolm Wiener, South Kent, CT (US)

Correspondence Address: SMITH, GAMBRELL & RUSSELL, LLP, SUITE 800, 1850 M STREET, N.W., WASHINGTON, DC, 20036, US

(21) Appl. No.: 09/801,841

(22) Filed: Mar. 9, 2001

Related U.S. Application Data
(60) Provisional application No. 60/188,169, filed on Mar. 10, 2000.

(51) Int. Cl. E04B 1/72; A01K 3/00

(52) U.S. Cl. 52/101

(57) ABSTRACT

This invention relates to an animal barrier device comprising a cylinder, preferably hollow, with a longitudinal hole traversing its length. The device can be used for mounting on a bird feeder support cable to deter animal passage. The device includes a cylinder, having a central hole for mounting on a cable.

### RELATED APPLICATIONS

This application claims priority to Provisional U.S. Patent Application No. 60/188,169, filed Mar. 10, 2000. This parent application is entirely incorporated herein by reference.

### FIELD OF THE INVENTION

This invention relates to a passive mechanical small animal barrier for elevated support cables particularly suited for protecting a feeder for birds. The bird feeder may be suspended from a vertical support cable, or it may be stabilized in suspension by a horizontal support cable.

### BACKGROUND OF INVENTION

There are many situations in which it is desirable to prevent small animals such as squirrels from passing along a suspended cable. For example, it is desirable to keep squirrels or other animals from climbing along clothes lines, or more particularly, from climbing along support cables to reach a bird feeder.

### PRIOR ART

The most commonly used protector is a large disc mounted to the cable, such as that shown in U.S. Pat. Nos. 2,493,107, and 4,523,546. These discs suffer drawbacks which prevent them from being successful animal barriers on horizontal cables. They are large and unwieldy and may also provide a perch that the squirrels may jump to from the surrounding trees in their effort to reach the feeder.

Another type of aerial cable guard is disclosed in U.S. Pat. No. 4,262,169. The patented device is designed to prevent animals from chewing on the cable; the device is counterbalanced to maintain it in an upright position. When an animal steps on the top, the device rotates to prevent the animal from getting at the cable. However, squirrels are very adept at walking in a “bear hug” fashion down or along the length of an object, and thus could simply use the patented device as a walkway.

Another device, disclosed in U.S. Pat. No. 4,867,104, is designed to prevent squirrels from climbing up from below and reaching the bird feeder. The device has a number of small rotating blocks mounted on a fixed shaft. However, if used in a horizontal orientation, since the blocks are all of the same size, a squirrel would be able to balance on the blocks sufficiently to allow it to run across their tops, or even climb along their bottoms, to defeat the device.

### SUMMARY OF INVENTION

It is therefore an object of this invention to provide a cable animal barrier which is effective in preventing squirrels from passing. It is a further object of this invention to provide such a barrier which has a relatively small outer diameter so that it cannot be used as a perch. It is a further object of this invention to provide such a barrier which is long enough so that a squirrel or other animal cannot simply reach past to traverse the length.

It is a further object of this invention to provide such a barrier which is wide enough so that it cannot be traversed by an animal down or along the side in a bear hug fashion. It is a further object of this invention to provide such a barrier which is light-weight and does not add significantly to the load on the cable.

This invention results from the realization that a truly effective animal barrier may be accomplished with a cylinder, preferably hollow, with a longitudinal hole traversing its length. This invention features an animal barrier for mounting on a bird feeder support cable to deter animal passage, including a cylinder, having a central hole for mounting on a cable.

The hole may be wide enough to allow the barrier cylinder to roll over, if suspended horizontally, when a small animal climbs upon it. The hole may also be small enough so as to clamp the cable, or be supported otherwise, if suspended vertically. The outer wall of the cylinder is wide enough to prevent grasping in a bear hug fashion and smooth enough to prevent traction by an animal that is attempting to traverse it by grasping the side.

The length of the cylinder is long enough to prevent even the larger species of grey squirrel from reaching past the cylinder to grasp the support cable on the far side. The cylinder may be of any length, although 6 inches to 12 inches is desirable for presenting a barrier to the most common species of animals. Multiple cylinders may be mounted to extend the length of the cable barrier to enhance the barrier effect.

The cylinder elements are preferably made of a lightweight material, such as a plastic, that is also durable against the elements. The parts may be produced by extrusion or injection molding. The material should be sufficiently dense and yet not brittle so as to be subject to gnawing by squirrels or other rodents over time.

### BRIEF DESCRIPTION OF THE DRAWINGS

Other objects, features and advantages will occur to those skilled in the art from the following description of a preferred embodiment and the accompanying drawings, in which:

FIG. 1 is an elevational view of an animal barrier according to this invention mounted on a horizontal support cable for a bird feeder;

FIG. 2 is an axonometric view of the animal barrier according to this invention showing the rotatable arrangement around a horizontal support cable; and

FIG. 3 is a cross-sectional view of inner and outer cylindrical elements of the barrier of FIG. 2.

FIG. 4 is a side view of the animal barrier according to this invention when attached to a vertically descending support cable for a bird feeder.

FIG. 5 is a side view of the animal barrier according to another embodiment of the invention in which the bird feeder is stabilized in suspension by a horizontal support cable. One unit of the animal barrier is deployed on each cable providing horizontal support to the bird feeder.

FIG. 6 is a side view of the animal barrier according to another embodiment of the invention in which the bird feeder is stabilized in suspension by a horizontal support cable and multiple units of the animal barrier are employed on one support cable to extend the length and enhance the barrier effect.

### DETAILED DESCRIPTION

This invention may be accomplished in an animal barrier for mounting on a cable to deter animal passage including a relatively large cylindrical element having a central hole for mounting on a cable, the cylindrical element preferably comprising a unitary symmetrical member such as a cylinder that also has a central hole for mounting on the cable. The device may further include a hollow space between an inner cylinder wall defining the hole and an outer cylinder wall defining the cylindrical element.

The device is made of a hard lightweight substance, preferably plastic, that is sufficiently light in weight so that it does not unduly burden the support cable on which it is mounted. The substance is also durable to withstand prolonged exposure to elements such as sunlight, rain and falling objects. It must also be sufficiently hard so as to withstand the gnawing that small rodents usually inflict on such barrier materials.

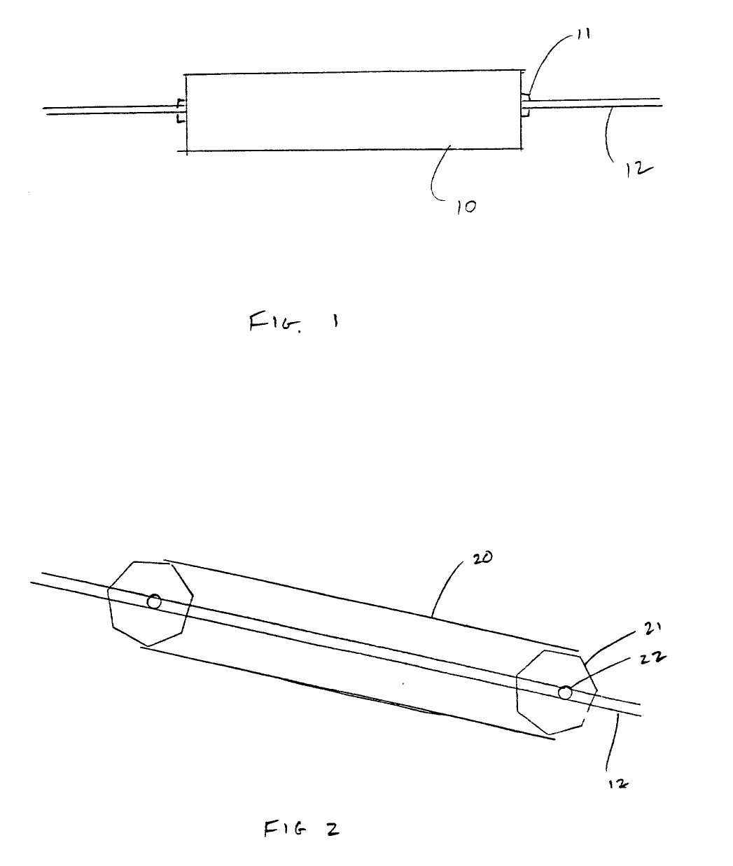

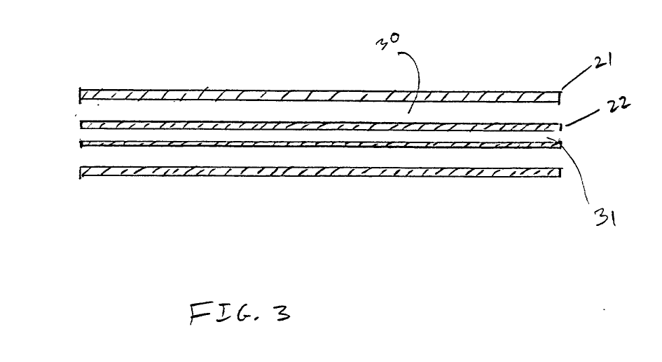

There is shown in FIG. 1 animal barrier 10 according to this invention including a lip to provide reinforcement at the point wherein the support cable 12 passes into the barrier element. An alternative embodiment 20 is shown in FIG. 2. Barrier 20 comprises only an outer cylinder 21 and an inner cylinder 22. The supporting cable 12 passes through the inner cylinder 22 without any clamping or other means that would inhibit its rolling when the squirrel attempts to traverse over the top.

FIG. 3 represents a cutaway view of the outer cylinder wall 21 and inner cylinder wall 22 that define a hollow space 30 so as to maximize the absence of any undue weight on the support cable as it passes through the inner space 31 between the inner cylinder walls. Although the inner cylinder wall 22 and outer cylinder wall 21 may be made of the same materials, they may also be constructed from distinct materials to maximize their functional properties.

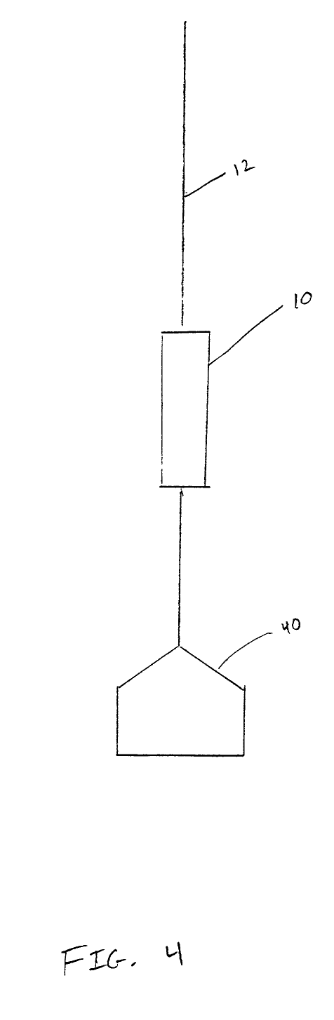

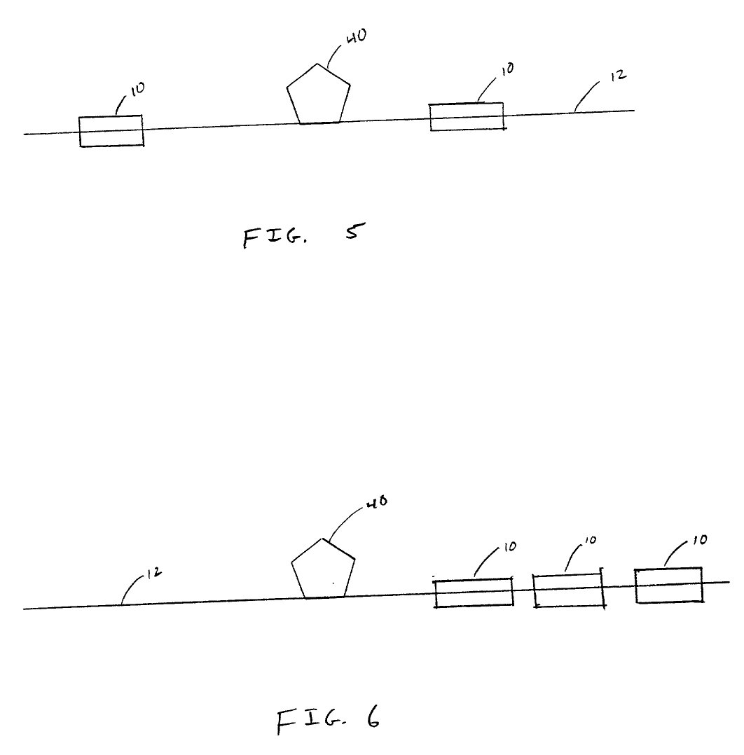

In FIG. 4, the barrier device according to the invention is clamped, or otherwise attached, to a vertically descending support cable 12 attached to a bird feeder 40. The animal barrier may be employed in a horizontal embodiment wherein the bird feeder is suspended or stabilized by horizontal support cables as in FIG. 5. Alternatively, as shown in FIG. 6, multiple units of the animal barrier may be also be utilized in tandem on one support cable to extend the effective length of the animal barrier to enhance the barrier effect upon encroaching squirrels or other animals.

Although specific features of the invention are shown in some drawings and not others, this is for convenience only as each feature may be combined with any or all of the other features in accordance with the invention. Other embodiments will occur to those skilled in the art.

What is claimed:

1. An animal barrier device, for mounting on a cable to deter animal passage along the cable, said device comprising:
an inner cylinder wall and an outer cylinder wall, wherein the outer cylinder wall has a diameter of more than 0.3 inches, and said walls form a cylinder.

2. The device according to claim 1, wherein the cylinder has a length of more than about four inches.

3. The device according to claim 1, wherein the cylinder has a length of from about six inches to about twelve inches.

4. The device according to claim 1, wherein the cylinder has a length of about six inches.

5. The device according to claim 1, wherein the cylinder has a length of about twelve inches.

6. A method of using the device according to claim 1, said method comprising placing the device in an environment to prevent access of an animal to that environment.
